(19) United States
(12) Patent Application Publication
(10) Pub. No.: US 2004/0188038 A1
(43) Pub. Date: Sep. 30, 2004

(54) Laborsaving venetian blind

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: NIEN MADE ENTERPRISE CO., LTD., Taichung (TW)

(21) Appl. No.: 10/429,739

(22) Filed: May 6, 2003

(30) Foreign Application Priority Data
Mar. 28, 2003 (TW) 92204857

(51) Int. Cl. E06B 9/30

(52) U.S. Cl. 160/168.1 R

(57) ABSTRACT

A laborsaving Venetian blind includes a headrail fixedly fastened to a top side of a window, a bottom rail spaced below the headrail, a set of slats, ladder tapes holding the slats in parallel between the headrail and the bottom rail, two laborsaving guides mounted in the bottom rail, each laborsaving guide having two rollers corresponding to front and rear sides of the slats, and two lift cords. Each lift cord has first end fixedly fastened to the headrail and a second end extending downwards from the headrail toward a front side of the bottom rail and then extending through the rollers of one laborsaving guide to a back side of the bottom rail and then extending upwards to the headrail for operation by the user.

### BACKGROUND OF THE INVENTION

1. Field of the Invention

The present invention relates generally to window coverings and, more particularly, to a laborsaving Venetian blind.

2. Description of the Related Art

A regular Venetian blind is generally comprised of a headrail, a bottom rail, a set of slats, pairs of ladder tapes, two lift cords, and a lift lock. The headrail is fixedly fastened to the top side of the window. The bottom rail is suspended below the headrail. The slats are arranged in parallel between the headrail and the bottom rail, each having two elongated through holes. The ladder tapes are bilaterally connected between the headrail and the bottom rail at the front and back sides to join the slats. The lift cords each have a fixed end respectively fixedly fastened to the bottom rail and a free end respectively upwardly extended through the through holes of the slats into the inside of the headrail and then extended out of the lift lock near one end of the headrail. Operating the lift cords controls the elevation of the bottom rail. When operating this structure of Venetian blind, the user must employ much pull the free ends of the lift cords with much effort to lift the bottom rail. The bottom rail of a conventional Venetian blind may be molded from plastics in a hollow structure. However, when lifting the bottom rail, slats are accumulated on the bottom rail, and the user must employ more effort when continuously pulling the lift cords to lift the bottom rail.

In order to eliminate the aforesaid problem, laborsaving Venetian blinds are developed. FIG. 1 illustrates a laborsaving Venetian blind according to the prior art. According to this design, two plugs 4 are respectively mounted in the bottom rail 1 corresponding to the through holes 3 of the slats 2, and two pulleys 5 are respectively pivoted to the plugs 4 to guide the lift cords 6. The lift cords 6 each have one end fixedly fastened to the headrail 7, and the other end respectively downwardly inserted through the through holes 3 of the slats 2 and respectively extended over the pulleys 5 and then respectively upwardly inserted through the through holes 3 of the slats 2 into the inside of the headrail 7 and then extended through the lift lock 8 to the outside of the headrail 7 for operation. By means of the pulleys 5, the user can pull the lift cords 6 to lift the bottom rail 1 with less effort. This structure of laborsaving Venetian blind is easy to operate, however it is still not satisfactory in function. When operating the ladder tapes 9 to tilt the slats 2, outside light source passes through the elongated through holes 3 of the slats 2 into the inside of the room, lowing the light shading effect of the blind.

### SUMMARY OF THE INVENTION

It is the main object of the present invention to provide a Venetian blind, which enables the user to lift and lower the bottom rail with less effort.

It is another object of the present invention to provide a laborsaving Venetian blind, which greatly improves the light shading effect of the slats.

To achieve these objects of the present invention, the laborsaving Venetian blind comprises a headrail fixedly fastened to a top side of a window; a bottom rail spaced below the headrail; a set of slats arranged in parallel between the headrail and the bottom rail; a bearing structure holding the slats in parallel between the headrail and the bottom rail; two laborsaving guides mounted in the bottom rail and horizontally spaced from each other at a distance, the laborsaving guides each having at least two rollers respectively fastened pivotally with the bottom rail in front and rear sides of the bottom rail corresponding to front and rear sides of the slats; and two lift cords each having a first end fixedly fastened to the headrail, and a second end extending downwards from the headrail toward the front side of the bottom rail and then extending through the at least two rollers of one of the laborsaving guides to the back side of the bottom rail and then extending upwards to the headrail for operation by the user.

### BRIEF DESCRIPTION OF THE DRAWINGS

FIG. 1 is a perspective view of a laborsaving Venetian blind according to the prior art.

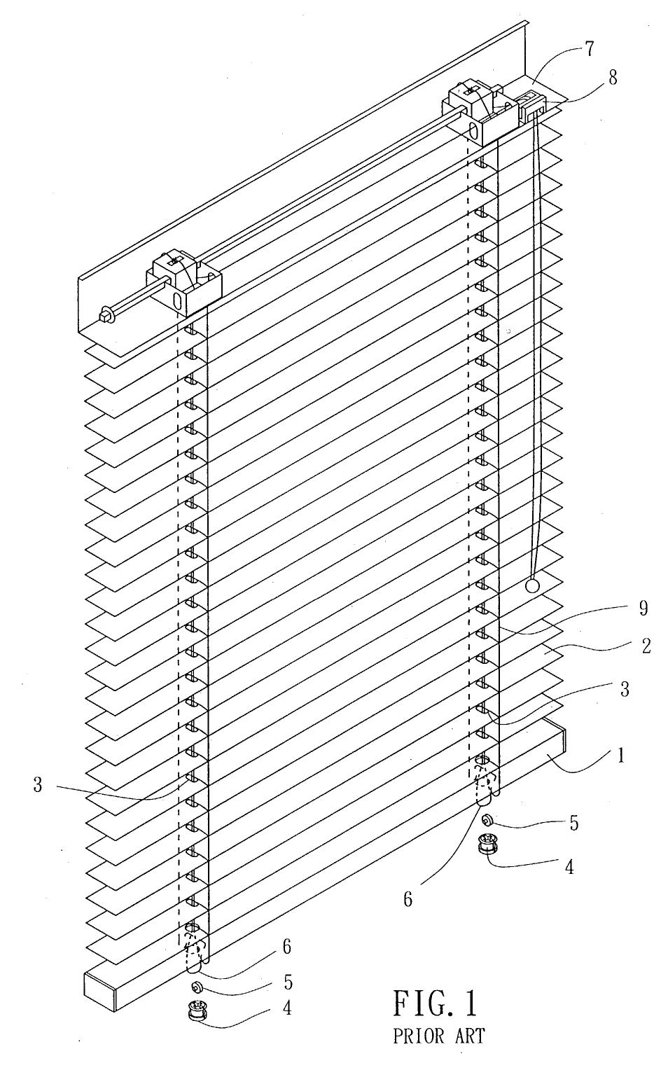

FIG. 2 is a perspective view of a laborsaving Venetian blind according to a first preferred embodiment of the present invention.

FIG. 3 is an exploded view in an enlarged scale of one laborsaving guide of the laborsaving Venetian blind according to the first preferred embodiment of the present invention.

FIG. 4 is an exploded view in an enlarged scale of a part of FIG. 2.

FIG. 5 is a sectional view in an enlarged scale of a part of FIG. 2, showing the positioning of the laborsaving guide in the bottom rail.

FIG. 6 is an exploded view of a laborsaving guide for a laborsaving Venetian blind according to a second preferred embodiment of the present invention.

FIG. 7 is a perspective view of a part of a laborsaving Venetian blind according to a third preferred embodiment of the present invention.

### DETAILED DESCRIPTION OF THE INVENTION

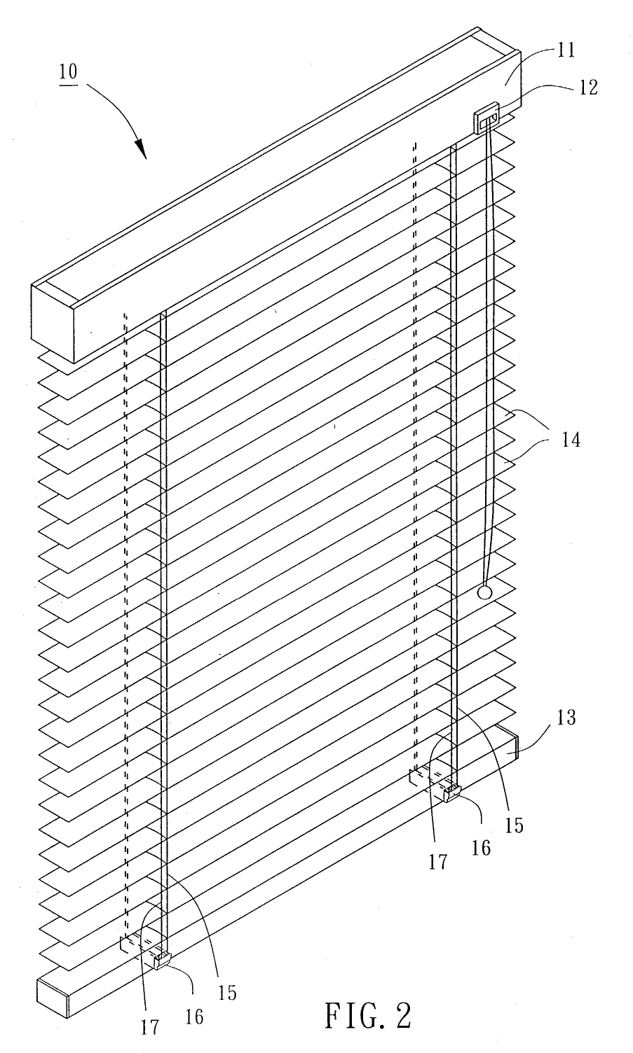

Referring to FIGS. 2-5, a laborsaving Venetian blind 10 in accordance with the first preferred embodiment of the present invention is shown comprised of a headrail 11, a lift lock 12, a bottom rail 13, a set of slats 14, a bearing structure, two laborsaving guides 16, and two lift cords 17.

As illustrated in FIG. 2, the headrail 11 is a hollow elongated rectangular bar fixedly fastened to the top side of a window (not shown) in horizontal.

The lift lock 12 is constructed subject to conventional techniques and installed in the headrail 11 near its one end, and adapted to lock the lift cords 17.

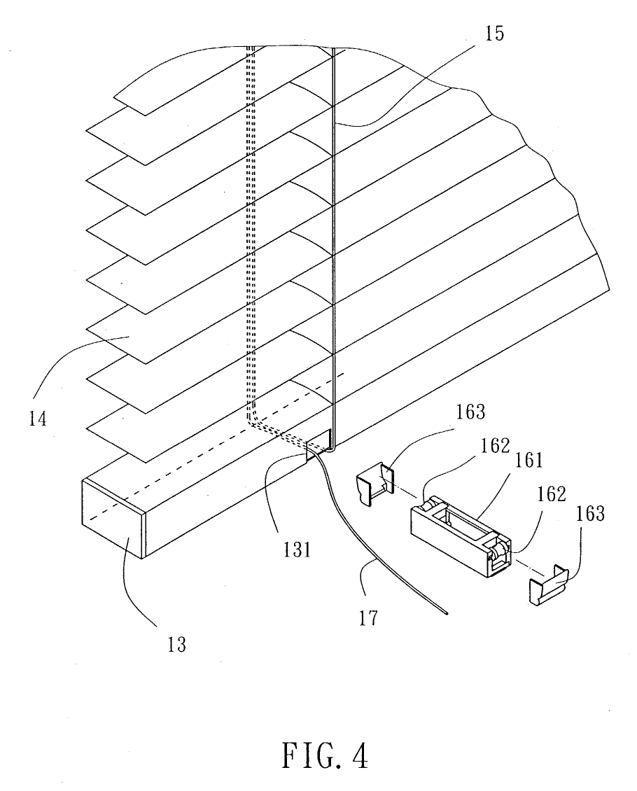

The bottom rail 13 is a hollow elongated rectangular bar horizontally suspending below the headrail 11, having two receiving holes 131 through the front and back sides (the two opposite long sides) near the two distal ends (see FIG. 4).

The slats 14 are horizontally arranged in parallel between the headrail 11 and the bottom rail 13.

The bearing structure is comprised of two ladder tapes 15. The ladder tapes 15 are symmetrically and bilaterally connected between the headrail 11 and the bottom rail 13 to hold the slats 14 in parallel between the headrail 11 and the bottom rail 13, keeping the slats 14 equally spaced at different elevations.

The two laborsaving guides 16 are respectively mounted in the receiving holes 131 of the bottom rail 13, each comprised of a main body 161, two rollers 162, and two caps 163.

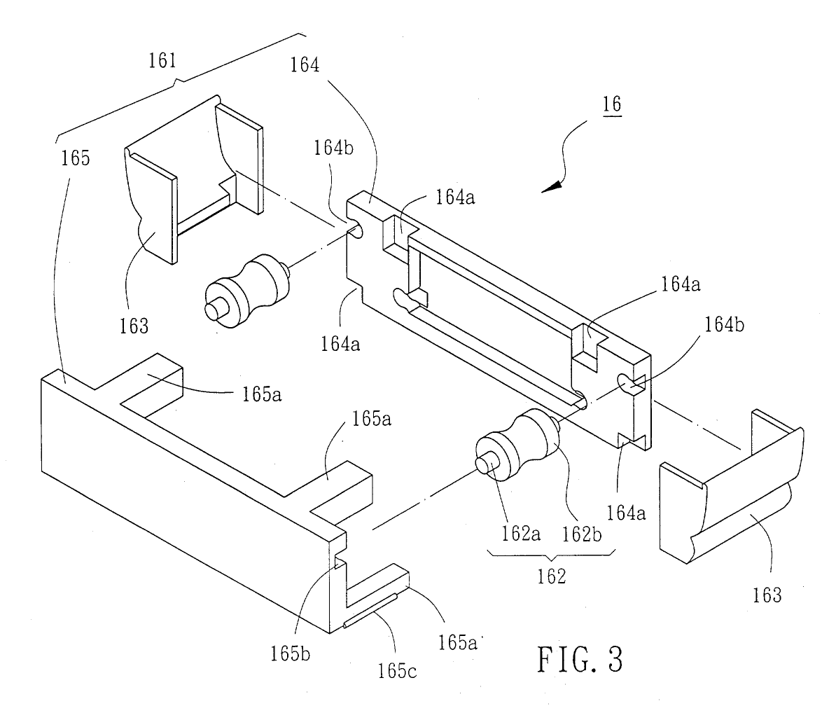

As illustrated in FIG. 3, the main body 161 is comprised of a first cover plate 164 and a second cover plate 164. The first cover plate 164 is a rectangular plate having four locating holes 164a and two axle holes 164b. Two locating holes 164a are respectively formed in the two distal ends of one long side of the first cover plate 164. The other two locating holes 164a are respectively disposed near the two distal ends of the other long side of the first cover plate 164. The two axle holes 164b are respectively disposed near the two short sides of the first cover plate 164. The second cover plate 165 is a rectangular plate having four locating bars 165a, two axle holes 165b, and two positioning members 165c. The locating bars 165 are perpendicularly extended from the second cover plate 165 corresponding to the locating holes 164a of the first cover plate 164. The locating bars 165 have a cross section fitting the cross section of the locating holes 164a so that the first cover plate 164 and the second cover plate 165 can be fastened together by fitting the locating bars 165a into the locating holes 164a respectively. When the first cover plate 164 and the second cover plate 165 fastened together, a receiving space is defined between the cover plates 164 and 165. The axle holes 165b are formed in the second cover plate 165 and respectively aimed at the axle holes 164b of the first cover plate 164. The positioning members 165c are members of smoothly arched cross section respectively longitudinally located on the two locating bars 165a in the two distal ends of one long side of the second cover plate 165 at an outer side.

The two rollers 162 each are comprised of an axle 162a and a roller body 162b. The axle 162a is axially inserted through the roller body 162b and extended out of the two distal ends of the roller body 162b. When the axle 162a fixed in position, the roller body 162b can be turned about the axle 162a. The axles 162a of the rollers 162 are respectively fastened to the axle holes 164b and 165b of the cover plates 164 and 165, for enabling the roller bodies 162b of the rollers 162 to be rotated inside the main body 161.

The two end caps 163 are respectively covered on the short sides of the cover plates 164 and 165, holding the cover plates 164 and 165 firmly together.

The two lift cords 17 are vertically arranged in parallel between the headrail 11 and the bottom rail 13, each having a first end fixedly fastened to one long side of the headrail 11, and a second end extending downwards to the bottom rail 13 and then inserted through one receiving hole 131 of the bottom rail 13 and then extending upwards to the headrail 11 and then extending through the lift lock 12 to the outside of the headrail 11 for operation. Operating the lift cords 17 controls the elevation of the bottom rail 13. When the lift lock 12 engages the lift cords 17, the bottom rail 13 is held in position. When the lift cords 17 disengaged from the lift lock 12, the user can operate the lift cords 17 to lift or lower the bottom rail 13.

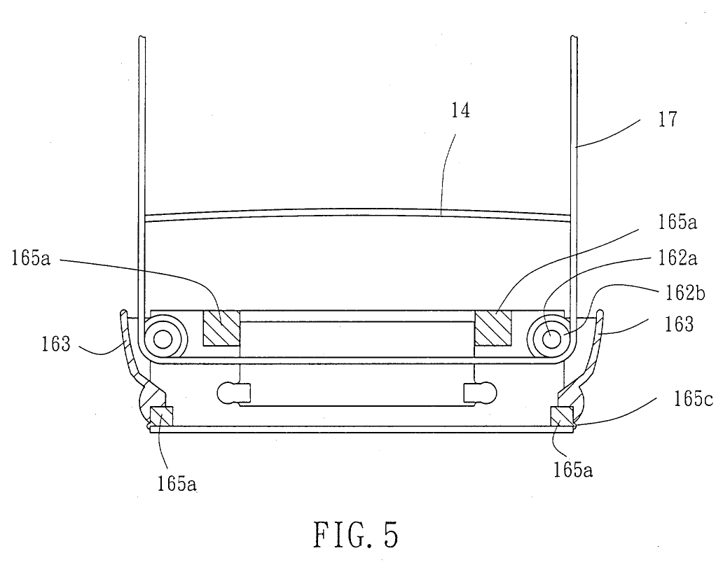

Referring to FIGS. 4 and 5 again, during installation of the laborsaving guides 16, the rollers 162 of each laborsaving guide 16 are mounted in the respective main body 161, and then the assembly of the main body 161 and rollers 162 for each laborsaving guide 16 is respectively inserted into the receiving holes 131 of the bottom rail 13, forcing the positioning members 165c of each laborsaving guide 16 into engagement with two opposite side edges of the corresponding receiving hole 131 to hold the respective main body 161 in plate. Thereafter, the first end of each lift cord 17 is respectively fastened to the headrail 11, and then the second end of each lift cord 17 is inserted into one receiving hole 131 of the bottom rail 13 and the corresponding main body 161 and extending over the roller body 162b of each roller 162 of the corresponding laborsaving guide 16 and then extending out of the corresponding receiving hole 131 to the headrail 11 and the lift lock 12. Thereafter, the end caps 163 of each laborsaving guide 16 are respectively closed on the two ends of the respective main body 161 to keep the corresponding receiving hole 131 from sight. Because the distance between the outer side of each of the two rollers 162 of each laborsaving guide 16 is approximately equal to the width of each slat 14, the lift cords 17 are suspended at two opposite sides of the slats 14 when extended through the rollers 162.

The operation and advantages of the present invention are outlined hereinafter. When the user operating the lifting cords 17 to unlock the lift lock 12 and then pulling the lift cords 17, the weight of the bottom rail 12 is evenly distributed through the headrail 11 and the user's hand (because the first end of each lift cord 17 is fixedly connected to the headrail 11 and the second end of each lift cord 17 is held in the user's hand). Therefore, the user can pull the lift cords 17 to lift the bottom rail 13 with less effort (about one half of the weight of the bottom rail 13 is shared by the head rail 11). Further, because the two rollers 162 of each laborsaving guide 16 (the rollers included) are disposed in two opposite sides of the bottom rail 13, i.e., the distance between the outer side of each of the two rollers 162 is approximately equal to the width of each slat 14, the lift cords 17 are suspended at two opposite sides of the slats 14 when extended through the rollers 162. Therefore, it is not necessary to make holes in the slats 14 for the passing of the lift cords 17.

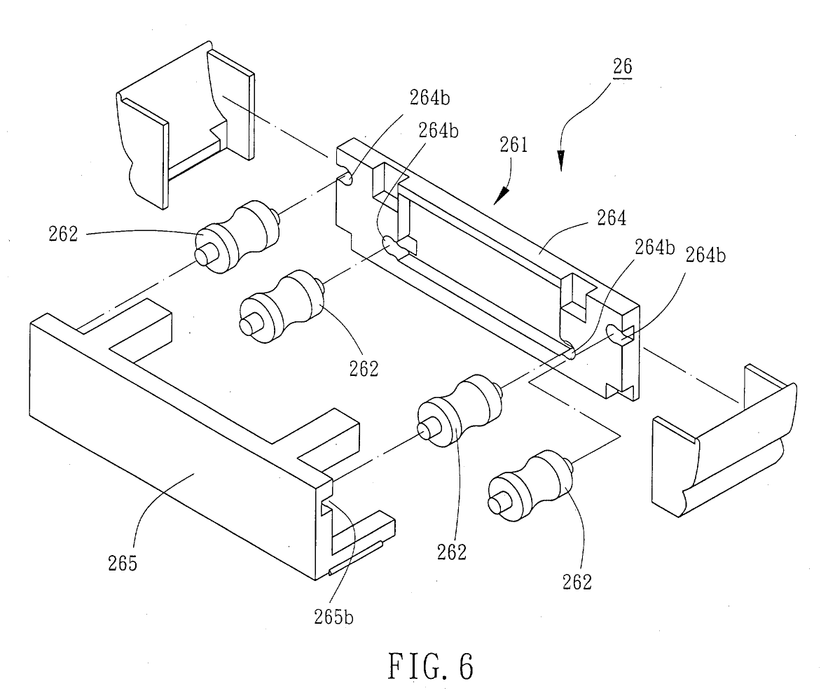

FIG. 6 is an exploded view of a laborsaving guide for a laborsaving Venetian blind according to the second preferred embodiment of the present invention. According to this embodiment, the laborsaving guide, referenced by 26, comprises four rollers 262 arranged in the main body 261 between the first cover plate 264 and the second cover plate 265. The cover plates 264 and 265 have axle holes 264b and 265badapted to accommodate the rollers 262. Increasing the number of the rollers 262 enables the lift cords to be moved smoothly.

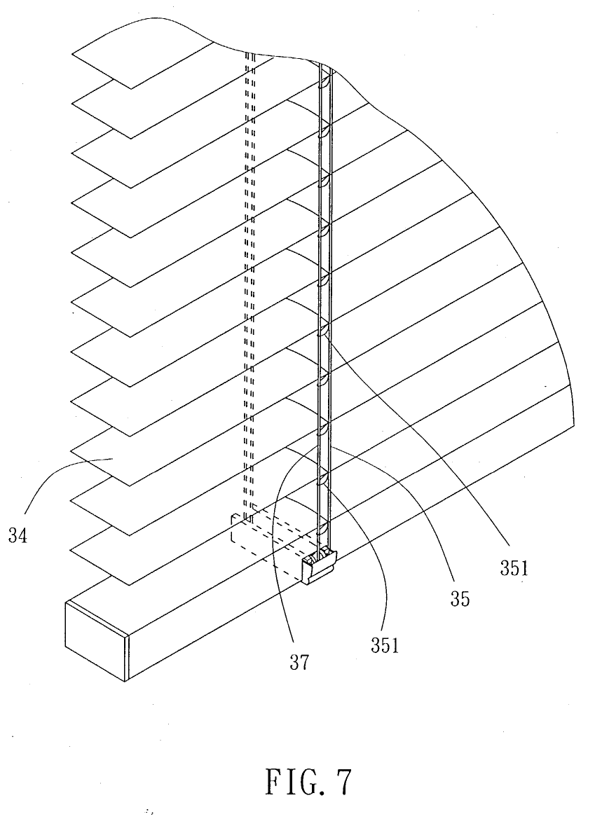

FIG. 7 is a perspective view of a part of a laborsaving Venetian blind according to the third preferred embodiment of the present invention. According to this embodiment, each ladder tape 35 has lift cord loops 351 disposed at different elevations corresponding to the slats 34 for guiding the lift cords 37.

What is claimed is:

1. A Venetian blind comprising:
a headrail fixedly fastened to a top side of a window;
a bottom rail spaced below said headrail;
a set of slats arranged in parallel between said headrail and said bottom rail;
a bearing structure holding said slats in parallel between said headrail and said bottom rail;
two laborsaving guides mounted in said bottom rail, said laborsaving guides each having at least two rollers corresponding to front and rear sides of said slats substantially; and
two lift cords each having a first end fixedly fastened to said headrail, and a second end extending downwards from said headrail toward a front side of said bottom rail and then extending through the two rollers of one of said laborsaving guides to a back side of said bottom rail and then extending upwards to said headrail for operation by the user.

2. The Venetian blind as claimed in claim 1, wherein said bottom rail has two receiving holes disposed near two distal ends thereof for accommodating said laborsaving guides therein.

3. The Venetian blind as claimed in claim 1, wherein said bearing structure is comprised of two ladder tapes bilaterally connected between said headrail and said bottom rail at front and back sides and respectively joining the front and rear sides of said slats.

4. The Venetian blind as claimed in claim 3, wherein said ladder tapes each having a plurality of lift cord loops disposed at different elevations corresponding to said slats for passing of said lift cords therethrough.

5. The Venetian blind as claimed in claim 1, wherein said laborsaving guides each further comprise a main body for pivotally accommodating the respective at least two rollers, and two end caps capped on two ends of said main body.

6. The Venetian blind as claimed in claim 5, wherein the main body of each of said laborsaving guides is comprised of a first cover plate and a second cover plate, said first cover plate and said second cover plate being fastened to each other and defining a receiving space therebetween, said first cover plate having a plurality of locating holes, said second cover plate having a plurality of locating bars respectively press-fitted into said locating holes of said first cover plate.

7. The Venetian blind as claimed in claim 5, wherein the main body of each of said laborsaving guides has a plurality of axle holes for accommodating the respective at least two rollers.

8. The Venetian blind as claimed in claim 5, wherein the main body of each of said laborsaving guides has two positioning members respectively forced into engagement with said bottom rail.

9. The Venetian blind as claimed in claim 1, further comprising a lift lock mounted in said headrail for locking said lift cords.
